(19) United States
(12) Patent Application Publication
(10) Pub. No.: US 2013/0275108 A1
(43) Pub. Date: Oct. 17, 2013

(54) PERFORMANCE SIMULATION OF SERVICES

(71) Applicants: Jiri Sofka, Sedlcany (CZ); Josef Troch, Pecky (CZ); Martin Podval, Velky Osek (CZ)

(72) Inventors: Jiri Sofka, Sedlcany (CZ); Josef Troch, Pecky (CZ); Martin Podval, Velky Osek (CZ)

(21) Appl. No.: 13/446,512

(22) Filed: Apr. 13, 2012

(51) Int. Cl. G06G 7/62

(52) U.S. Cl. 703/13

(57) ABSTRACT

A method for generating a performance simulation of a real service can include scheduling a time for a number of responses to be sent based on a number of response time metrics and determining a delay for the number of responses based on a number of data throughput metrics. The number of responses can then be sent based on the time and the delay.

### BACKGROUND

A service oriented architecture (SOA) environment can include a mesh of software services. Each service can implement a number of actions. The services can be owned and operated by the same organization as well as multiple organizations. If the services are owned by multiple organizations, some of the services can have restricted access and/or be paid services.

### BRIEF DESCRIPTION OF THE DRAWINGS

FIG. 1 illustrates a flow chart of an example method for generating a performance simulation of a real service according to the present disclosure.

FIG. 2 illustrates a box diagram of an example performance simulation module for generating a virtual simulation of a real service according to the present disclosure.

FIG. 3 illustrates an example computing device according to the present disclosure.

### DETAILED DESCRIPTION

Examples of the present disclosure include methods, systems, and computer-readable and executable instructions to generate a performance simulation of a real service. Methods for generating a performance simulation of a real service can include scheduling a time for a number of responses to be sent based on a number of response time metrics. Methods for generating a performance simulation of a real service can also include determining a delay for the number of responses based on a number of data throughput metrics. Furthermore, generating a performance simulation of a real service can include sending the number of responses based on the time and the delay.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

Within an SOA environment there can be a desire to execute a performance test on a composite application. The composite application can have a number of individual services. The number of individual services can be unavailable during a desired testing period. For example, the number of individual services can be owned by a third party and access may not be granted for the performance test of the composite application. A number of virtual services can be generated to replace the individual services (e.g., real services, third party services that are unavailable).

A performance test of the composite application utilizing the virtual services can determine an impact of a performance of the individual services on the overall performance of the composite application. For example, the performance of the virtual service can be adjusted to determine how different performance levels of the virtual service affect the overall composite application performance. In another example, the performance of the virtual service can be altered to determine a performance of the composite application for various performance levels of the virtual service. In this example, it can be determined that the virtual service needs to be at a desired performance for the composite application to run efficiently. The desired performance of the virtual service can include a response time and delay that enable the composite application to perform efficiently.

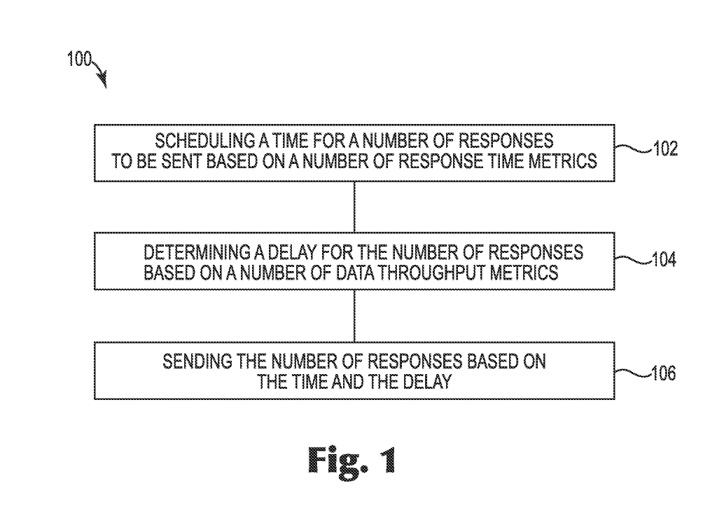

FIG. 1 illustrates a flow chart of an example method 100 for generating a performance simulation of a real service according to the present disclosure. The method 100 for generating a performance simulation of a real service can include utilizing a processor to execute instructions located on a non-transitory computer readable medium. The method 100 can also include replacing the real service with a virtual service.

At 102 a time for a number of responses to be sent is scheduled based on a number of response time metrics. The number of response time metrics can be obtained from monitoring and can be unique for each individual and/or real service. The number of response time metrics can also be calculated and determined without monitoring of the real service.

The number of response time metrics can be used to model a speed limitation based on a raw computing power of the service and scaling with respect to a load. The number of response time metrics can include a number of scalar values. The number of scalar values can include, but are not limited to, a base response time, a load threshold, a scaling coefficient and a response time tolerance.

The base response time can be a response time of a service, whose load is equal to a load threshold value or below the load threshold value for the service. The load threshold value can be a point where the service response time begins to increase with an increased service load. For example, the response time for the service can be stable (e.g., non-changing, changing within a response time tolerance, etc.) from a minimum service load to the load threshold, where the response time for the service begins to increase due to the service load.

The scaling coefficient can be used to determine a response time for the service based on a response time increase factor after the load threshold. For example, the scaling coefficient can be used in a mathematical equation, wherein a response time (milliseconds) can be calculated by utilizing a particular service load (transactions per second) and the scaling coefficient. The scaling coefficient can be determined by an equation of a graph that is produced by data corresponding to a number of service load values and a number of resulting response time values.

The response time tolerance can be a range of response times that are acceptable for a particular service load. For example, at a particular service load the response time tolerance could be a range from 1 millisecond to 3 milliseconds. The response time tolerance can take into account a number of real response time inconsistencies within a real service and incorporate these slight variations using the response time tolerance. For example, two responses from a real service at the same service load can have different response times. The different response times can fall within the response time tolerance for the virtual service.

At 104 a delay is determined for the number of responses based on a number of data throughput metrics. The number of data throughput metrics can be based on the time a real service takes to access and/or use a real service external resource (e.g., database, files system, network, etc.). The number of data throughput metrics can be used by the virtual service to model the speed limitations of a real service.

The data throughput metrics can define a maximal throughput (e.g., bytes per second) that the virtual service is allowed to generate at a particular time. The data throughput metrics can be adjusted to model various aspects of the real service. For example, a real service can have multiple types of connections to various external resources and each type of connection could have various throughput limitations. The throughput limitations and throughput metrics can be different for various real services.

At the time when the responses are scheduled to be sent, the throughput metrics can be checked to determine if the system is within throughput limitations. If the system is not within the throughput limitations, the response is rescheduled for a later time. A delay can be the amount of time between the scheduled time and the rescheduled later time. The delay can be determined based on the throughput metrics at the scheduled time.

At the rescheduled time the throughput metrics can be checked to determine if the system is within the throughput limitations. If the system is not within the throughput limitations the response is rescheduled for a different time. The rescheduled time can include a recalculation of the delay. For example, the time difference between the time (e.g., original scheduled time) and the reschedule time can be the recalculated delay. In some embodiments the recalculated delay can be a later time than the previous delay. The responses can be rescheduled until the system is within the throughput limitations. When the system is within the throughput limitations, the system can send the number of responses.

At 106 the number of responses are sent based on the scheduled time and delay. As described herein, the time can be the originally scheduled time to send the number of responses. The delay can be the total amount of time between the time (e.g., original scheduled time) and the sending of the number of responses.

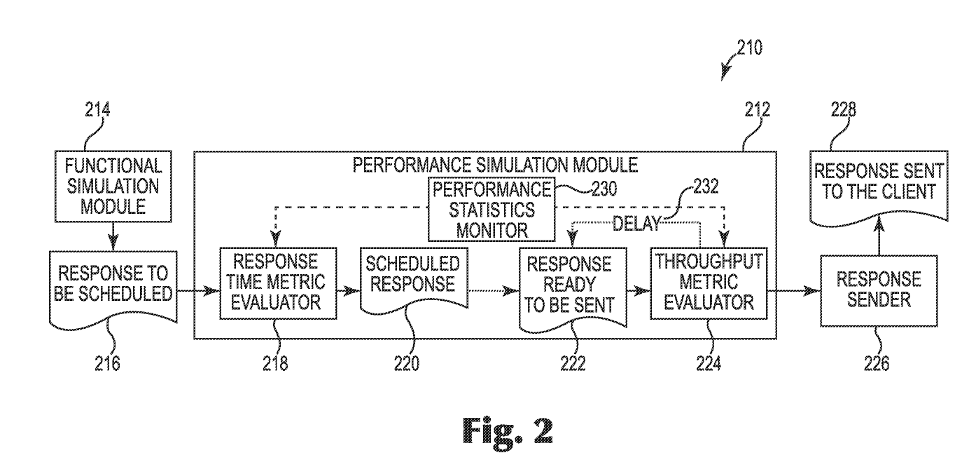

FIG. 2 illustrates a box diagram of an example performance simulation module 212 for generating a virtual simulation of a real service according to the present disclosure. The performance simulation module 212 can be a set of computer readable instructions stored in a non-transitory computer readable medium and executed by a number of processing resources to perform the various functions as described herein.

A functional simulation module 214 can produce a number of responses. The functional simulation module 214 can be independent (e.g., a different computing device, different software, different hardware, etc.) of the performance simulation module 212. The functional simulation module 214 can produce the number of responses based on a number of requests from a client. The functional simulation module 214 can be utilized to produce a correct (e.g., acceptable format, etc.) response to the request from the client.

At 216, the produced response can be sent to the response time metric evaluator 218. The response time metric evaluator 218 can schedule a time for the response to be sent to the client based on the response time metric. At 220 the response has a scheduled time to be sent to the client. There can be a delay between the time of scheduling and the scheduled time to be sent to the client. There can be a lapse between the time the response is scheduled 220 and when the response is ready to be sent 222 at the scheduled time.

At the scheduled time the response can be sent to the throughput metric evaluator 224 before being sent to the client. The throughput metric evaluator 224 can determine the throughput limitations of the system at the scheduled time based on the throughput metric and determine if sending the response is within the throughput limitations of the system.

If it is determined that sending the response is within the throughput limitations of the system the response sender 226 can send the response to the client. The response sent to the client 228 can be recorded to determine a performance of the virtual system. For example, the number of recorded responses could be used to determine a time between the request and resulting response. The user metrics can then be altered in order to increase the time between the requests and resulting responses and/or decrease the time between the requests and resulting responses. The altered user metrics can be utilized to test a composite system with a virtual system having varying performance.

If it is determined by the throughput metric evaluator 224 that sending the response is outside the throughput limitations, there can be a delay 232. A delay can be created due to a rescheduling of the response. After the delay 232, the response will be ready to be sent 222 at the rescheduled time. At the rescheduled time, the response can be sent to the throughput metric evaluator 224 to determine if sending the response at the rescheduled time is within the throughput limitations of the system. If it is determined by the throughput metric evaluator 340 that sending the response is within the throughput limitations of the system, the response sender 226 sends the response to the client as described herein.

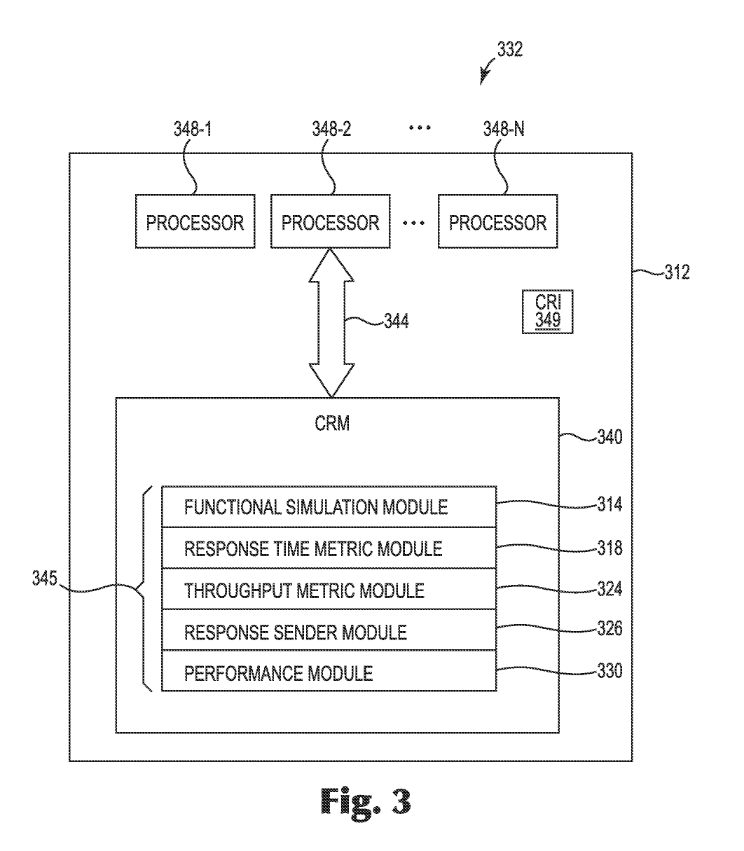

FIG. 3 illustrates an example computing system 332 according to an example of the present disclosure. The computing system 332 can include a computing device 312 that can utilize software, hardware, firmware, and/or logic to for generate a virtual simulation of a real service. The computing device 312 can include the performance simulation module 212 described in FIG. 2.

The computing device 312 can be any combination of hardware and program instructions configured to generate a virtual simulation of a real service. The hardware, for example can include one or more processing resources 348-1, 348-2, . . . , 348-N, computer readable medium (CRM) 340, etc. The program instructions (e.g., computer-readable instructions (CRI) 345) can include instructions stored on the CRM 340 and executable by the processing resources 348-1, 348-2, . . . , 348-N to implement a desired function (e.g., determine response time metrics, determine throughput metrics, etc.).

CRM 340 can be in communication with a number of processing resources of more or fewer than 348-1, 348-2, . . . , 348-N. The processing resources 348-1, 348-2, . . . , 348-N can be in communication with a tangible non-transitory CRM 340 storing a set of CRI 345 executable by one or more of the processing resources 348-1, 348-2, . . . , 348-N, as described herein. The CRI 345 can also be stored in remote memory managed by a server and represent an installation package that can be downloaded, installed, and executed. The computing device 312 can include memory resources 349, and the processing resources 348-1, 348-2, . . . , 348-N can be coupled to the memory resources 349.

Processing resources 348-1, 348-2, . . . , 348-N can execute CRI 345 that can be stored on an internal or external non-transitory CRM 340. The processing resources 348-1, 348-2, . . . , 348-N can execute CRI 345 to perform various functions, including the functions described in FIG. 1 and FIG. 2. For example, the processing resources 348-1, 348-2, . . . , 348-N can execute CRI 345 to implement the performance simulation module 212 from FIG. 2.

The CRI 345 can include a number of modules 314, 318, 324, 326, 330. The number of modules 314, 318, 324, 326, 330 can include CRI that when executed by the processing resources 348-1, 348-2, . . . , 348-N can perform a number of functions.

The number of modules 314, 318, 324, 326, 330 can be sub-modules of other modules. For example the functional simulation module 314 and the performance module 330 can be sub-modules and/or contained within a simulation module. In another example, the response time metric module 318 and the throughput metric module 326 can be sub-modules and/or contained within the performance module 330. Furthermore, the number of modules 314, 318, 324, 326, 330 can comprise individual modules separate and distinct from one another.

A functional simulation module 314 can produce a number of responses in a desired format (e.g., format of the requesting client). The functional simulation module 314 can send the produced response to a response time metric module 318. The functional simulation module can also send the number of responses in the desired format to the performance module 330.

The response time metric module 318 can schedule a time to send the produced response based on the response time metric. As described herein, the response time metric can be based on the raw computing power of a real service.

The throughput metric module 324 can determine if the system can send the response to a client based on the throughput metric. The throughput metric module 324 can evaluate a system capability for sending the produced response. The system capability can include a determination of the throughput limitations of the system at the scheduled time based on the throughput metric.

A determination can be made by the throughput metric module 324 that the system is within the throughput limitations, wherein the throughput metric module 324 can send the response to a response sender module 326.

A determination can be made by the throughput metric module 324 that the system is outside the throughput limitations, wherein the throughput metric module 324 can reschedule the response. By rescheduling the response the throughput metric module can create a delay. The delay can be a time that has passed from the scheduled time from the response time metric module 318 and the rescheduled time by the throughput metric module 324.

At the rescheduled time, the throughput metric module 324 can evaluate the system capability for the rescheduled time based on the throughput metric and determine if the system is within the throughput limitations.

The response sender module 326 can send the response to the client after the response time metrics and the throughput metrics are determined to be met by the response time metric module 318 and the throughput metric module 324 respectively.

The performance module 330 can monitor a performance of the performance simulation module 212. For example, the performance module can gather statistics of the virtual service (e.g., virtual service load, current throughput, etc.). The performance module can also enable a user to adjust various metrics (e.g., response time metric, throughput metric, etc.) to create different scenarios. For example, the performance module 330 can change the throughput metrics and/or response time metrics of the virtual service.

A non-transitory CRM 340, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 340 can be integral, or communicatively coupled, to a computing device, in a wired and/or a wireless manner. For example, the non-transitory CRM 340 can be an internal memory, a portable memory, a portable disk, or a memory associated with another computing resource (e.g., enabling CRIs to be transferred and/or executed across a network such as the Internet).

The CRM 340 can be in communication with the processing resources 348-1, 348-2, . . . , 348-N via a communication path 344. The communication path 344 can be local or remote to a machine (e.g., a computer) associated with the processing resources 348-1, 348-2, . . . , 348-N. Examples of a local communication path 344 can include an electronic bus internal to a machine (e.g., a computer) where the CRM 340 is one of volatile, non-volatile, fixed, and/or removable storage medium in communication with the processing resources 348-1, 348-2, . . . , 348-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 344 can be such that the CRM 340 is remote from the processing resources e.g., 348-1, 348-2, . . . , 348-N, such as in a network connection between the CRM 340 and the processing resources (e.g., 348-1, 348-2, . . . , 348-N). That is, the communication path 344 can be a network connection. Examples of such a network connection can include a local area network (LAN), wide area network (WAN), personal area network (PAN), and the Internet, among others. In such examples, the CRM 340 can be associated with a first computing device and the processing resources 348-1, 348-2, . . . , 348-N can be associated with a second computing device (e.g., a Java®server, network simulation engine 214). For example, a processing resource 348-1, 348-2, . . . , 348-N can be in communication with a CRM 340, wherein the CRM 340 includes a set of instructions and wherein the processing resource 348-1, 348-2, . . . , 348-N is designed to carry out the set of instructions.

The processing resources 348-1, 348-2, . . . , 348-N coupled to the memory 345 can execute CRI 345 to determine a response time metric and a data throughput metric. The processing resources 348-1, 348-2, . . . , 348-N coupled to the memory 345 can also execute CRI 345 to calculate a time for a number of responses to a number of requests based on the response time metric. The processing resources 348-1, 348-2, . . . , 348-N coupled to the memory 345 can also execute CRI 345 to evaluate a system capability for sending the number of responses at the time based on the data throughput metric. The processing resources 348-1, 348-2, . . . , 348-N coupled to the memory 345 can also execute CRI 345 to send the number of responses when the system capability is above a pre-determined load threshold. Furthermore, the processing resources 348-1, 348-2, . . . , 348-N coupled to the memory 345 can execute CRI 345 to record the response time metric and the data throughput metric from a real system and substitute the real system with a virtual service based on the response time metric and the data throughput metric.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for generating a performance simulation of a real service, comprising:
utilizing a processor to execute instructions located on a non-transitory medium for:
scheduling a time for a number of responses to be sent based on a number of response time metrics;
determining a delay for the number of responses based on a number of data throughput metrics; and
sending the number of responses based on the time and the delay.

2. The method of claim 1, wherein determining the delay includes rescheduling a time for the number of responses to be sent.

3. The method of claim 1, wherein scheduling the time is further based on a received request load level.

4. The method of claim 3, wherein replacing the real service with the virtual service comprises simulating various behaviors of the real service.

5. The method of claim 1, further comprising replacing the real service with a virtual service, wherein the virtual service sends the number of responses.

6. The method of claim 1, further comprising filtering the number of response time metrics and the number of data throughput metrics, wherein filtering comprises eliminating a number of outliers within the number of response time metrics and the number of data throughput metrics.

7. A non-transitory computer-readable medium storing a set of instructions executable by a processor to cause a computer to:
receive a response time metric and a data throughput metric for a real service;
schedule a reference time to send a number of responses based on the response time metric;
determine a throughput of the real service based on the data throughput metric for the reference time;
calculate an actual time to send the number of responses based on the throughput for the real service at the time; and
send the number of responses at the actual time.

8. The medium of claim 7, wherein the response time metric and the data throughput metric are altered to a set of model parameters.

9. The medium of claim 7, wherein the data throughput metric and the response time metric comprise data for a variety of behaviors for the real service.

10. The medium of claim 9, wherein the variety of behaviors are executed individually.

11. The medium of claim 7, wherein the throughput is above a load threshold and a delay time is determined.

12. A system for generating a performance simulation of a real service, the system comprising:
a processing resource in communication with a non-transitory computer readable medium, wherein the non-transitory computer readable medium includes a set of instructions and wherein the processing resource executes the set of instructions to:
determine a response time metric and a data throughput metric;
calculate a time for a number of responses to a number of requests based on the response time metric;
evaluate a system capability for sending the number of responses at the time based on the data throughput metric; and
send the number of responses when the system capability is above a pre-determined load threshold.

13. The system of claim 12, wherein the system capability is based on a recorded system capability of a real system.

14. The system of claim 12, wherein the system capability can be altered to simulate various performance models.

15. The system of claim 12, further comprising instructions executed to record the response time metric and the data throughput metric from a real system and substitute the real system with a virtual service based on the response time metric and the data throughput metric.
